(19) United States
(12) Patent Application Publication
(10) Pub. No.: US 2002/0022458 A1
(43) Pub. Date: Feb. 21, 2002

(54) Balun and a mixer and downconverter incorporating same

(76) Inventor: Hardial S. Gill, Backnang (DE)

Correspondence Address: Kirschstein, Ottinger, Israel & Schiffmiller, P.C., 489 Fifth Avenue, New York, NY, 10017-6105, US

(21) Appl. No.: 09/928,254

(22) Filed: Aug. 10, 2001

(30) Foreign Application Priority Data
Aug. 16, 2000 (DE) EP 00117612.2

(51) Int. Cl. H04B 1/40

(52) U.S. Cl. 455/87; 455/86; 455/78

(57) ABSTRACT

A balun comprises seven adjacently disposed coupled lines in a substantially symmetrical arrangement about a central one (33) of the seven lines. Corresponding first ends of the two outermost lines (30, 36), of the two thereto adjacent lines (31, 35) and of the central line are connected to each other and to an unbalanced port input (37) (Port 1). Corresponding first ends of the two lines (32, 34) adjacent the central line (33) are grounded, as are corresponding second ends of the central line (33) and of the two lines (31, 35) adjacent the outermost lines. Corresponding second ends of the outermost line (30) on one side of the central line (33) and the next but one line (32) on that same side form a first balanced port (Port 2), while equivalent second ends on the other side of the central line (33) form a second balanced port (Port 3). The balun may form part of a single-sideband mixer or of a downconverter.

### BACKGROUND OF THE INVENTION

The invention relates to a balun and a mixer and a downconverter incorporating such balun.

It is known to use baluns to provide transitions between symmetrical and unsymmetrical transmissions lines. With a symmetrical line, a signal being carried by the line does not have ground as a reference potential. By contrast, an unsymmetrical line is referenced on one side to ground, so that a signal carried by such a line does have ground as a reference potential. Baluns as described are often used in the input or output stages of double balanced mixers or modulators, etc.

A balun which consists of four mutually coupled planar lines is known from DE 197 29 761 A1 and is illustrated in FIG. 1. This balun has two couplers 1, 2, each of which has two planar lines 206, 208; 218, 220 coupled together over a length of one-quarter wavelength. Each of the couplers is designed as a two-pole bandpass filter, coupler 1 being arranged in an open circuit configuration and coupler 2 in a short-circuit configuration. The two quarter-wavelength long couplers are connected together to provide a three-port balun having a connection 3 for unsymmetrical signals and two connections 4, 5 for symmetrical signals. In the open-circuit configured coupler 1 the opposite ends 6, 7 of the two lines are unterminated. The other end 8 of one line (206) constitutes a symmetrical connection 4, while the other end 9 of the other line (208) is connected to one end of the close-circuit configured line coupler 2. Two opposite ends 10, 11 of the two lines of this latter line coupler are taken to ground and the other end 12 of one of the lines (220) forms a further connection 5 for symmetrical signals. The two interconnected ends of the two line couplers form the connecting port 3 for unsymmetrical signals. To achieve a tight coupling (e.g. 3 dB) between the lines, the balun is made using multilayer technology. Hence the manufacturing costs are high, which is a problem for the mass-production of, for example, GaAs monolithic integrated circuits.

The balun just described is a single balun and therefore cannot be used in star mixers and modulators and single-sideband mixers. For this purpose it is necessary to use a dual balun. One such device is the subject of a co-pending German patent application filed on Feb. 23, 2000 by Robert Bosch GmbH and is as shown in FIG. 2.

The balun of FIG. 2 consists of two three-line interdigitated sections. Each section is a quarter-wavelength long. The first and third lines 20, 21 of the first section are grounded at the unbalanced input port 22 and the other ends of the first and third lines are the terminals 23, 24 of the balanced ports A and B. The first and the third lines 25, 26 of the second section are grounded at one end 27, while the second end of these lines are the terminals 28, 29 of the balanced ports A and B. The central line 15 is connected at one end to the unbalanced port 22 and is left unterminated at the other end. The potentials at the four balanced port terminals of this dual balun are suitable for driving elements connected to the four diodes of a star mixer, for example. It consists of purely planar coupled structures and can be realised in single-layer printed-circuit technology. It has the drawback that it is a half-wavelength long in total and therefore takes up a lot of space on a microwave monolithic integrated circuit (MMIC) of which it is intended to form a part.

### SUMMARY OF THE INVENTION

In accordance with a first aspect of the invention, there is provided a balun as recited in claim 1. Under second and third aspects of the invention, the balun according to the invention is employed respectively as part of a single-sideband mixer arrangement, as recited in claim 5, and as part of a downconverter arrangement, as recited in claim 11. Specific embodiments of the balun, mixer and downconverter are covered by the subclaims.

### BRIEF DESCRIPTION OF THE DRAWINGS

An embodiment of the first aspect of the invention will now be described, by way of example only, with reference to the drawings, of which:

FIG. 1 is a schematic diagram of a known single balun;

FIG. 2 is a schematic diagram of a known dual balun;

FIG. 3 is a schematic diagram of a dual balun in accordance with the present invention;

FIG. 4 is cross-sectional diagram showing the construction of an airbridge interconnect;

FIG. 5 is a plan view of a microstrip layout incorporating a bypass interconnect;

FIG. 6 is a circuit diagram of a monolithic single-sideband mixer incorporating a dual balun according to the invention, and

FIG. 7 is a circuit diagram of a downconverter incorporating a dual balun in accordance with the invention.

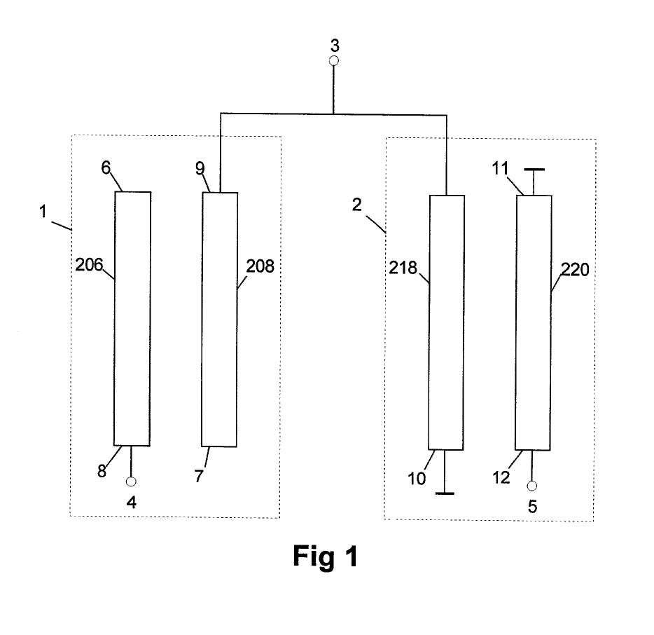

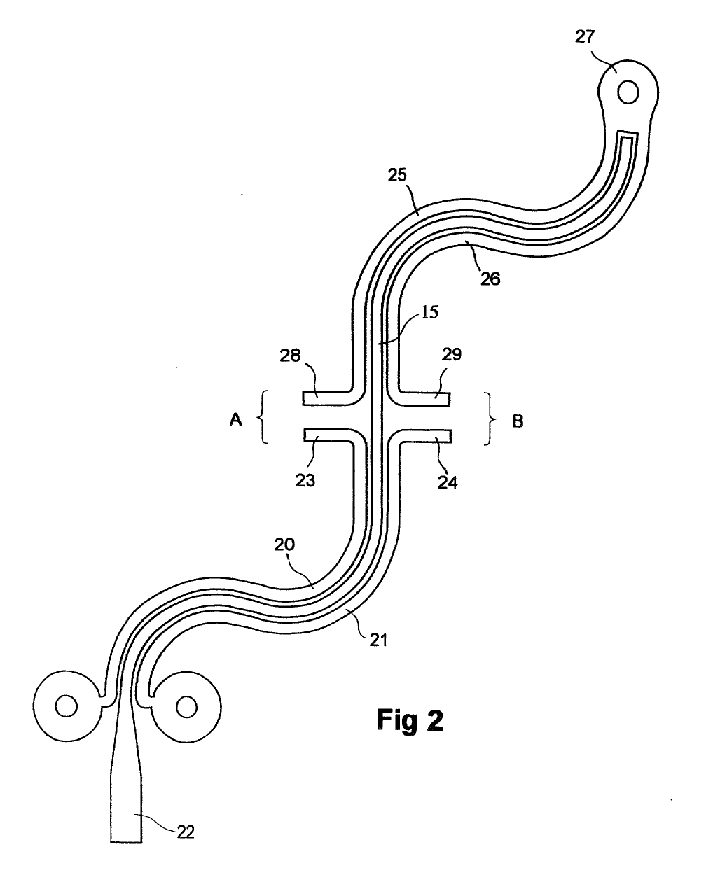

### DETAILED DESCRIPTION OF THE EMBODIMENTS

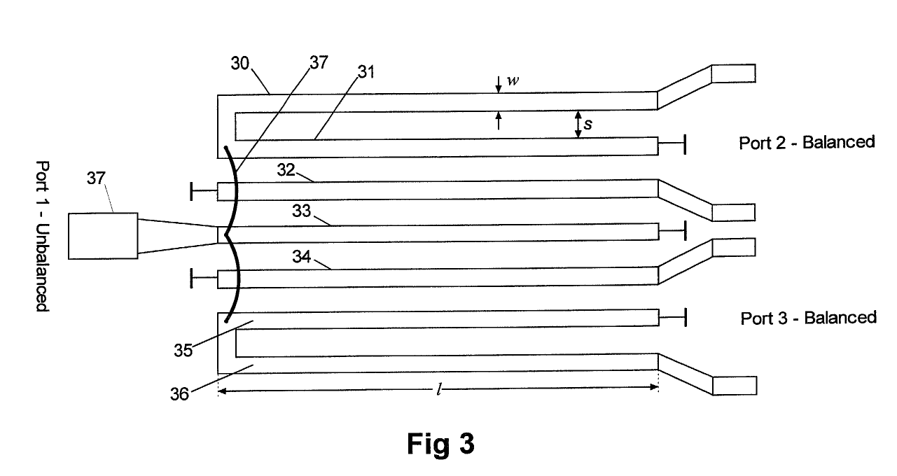

Referring now to FIG. 3, a dual balun according to the present invention comprises seven lines 30-36, each having a length equal to a quarter-wavelength at the mean frequency of operation of the balun. The central line 33 forms at one end the connection point for the unbalanced port 37 (Port 1) and is terminated at its other end by a connection to ground. First and second balanced ports (Ports 2 and 3, respectively) are formed from the corresponding ends of lines 30, 32 and lines 34, 36, respectively. The other end of lines 32 and 34 are grounded. Sandwiched between the lines making up each balanced port is a further line (lines 31 and 35) which is grounded at the balanced-port end. Finally, the unbalanced-port ends of lines 30 and 36 are connected by similar strip sections to the corresponding ends of lines 31 and 35, respectively, while the unbalanced-port ends of lines 31, 33 and 35 are coupled together by means of airbridges 37.

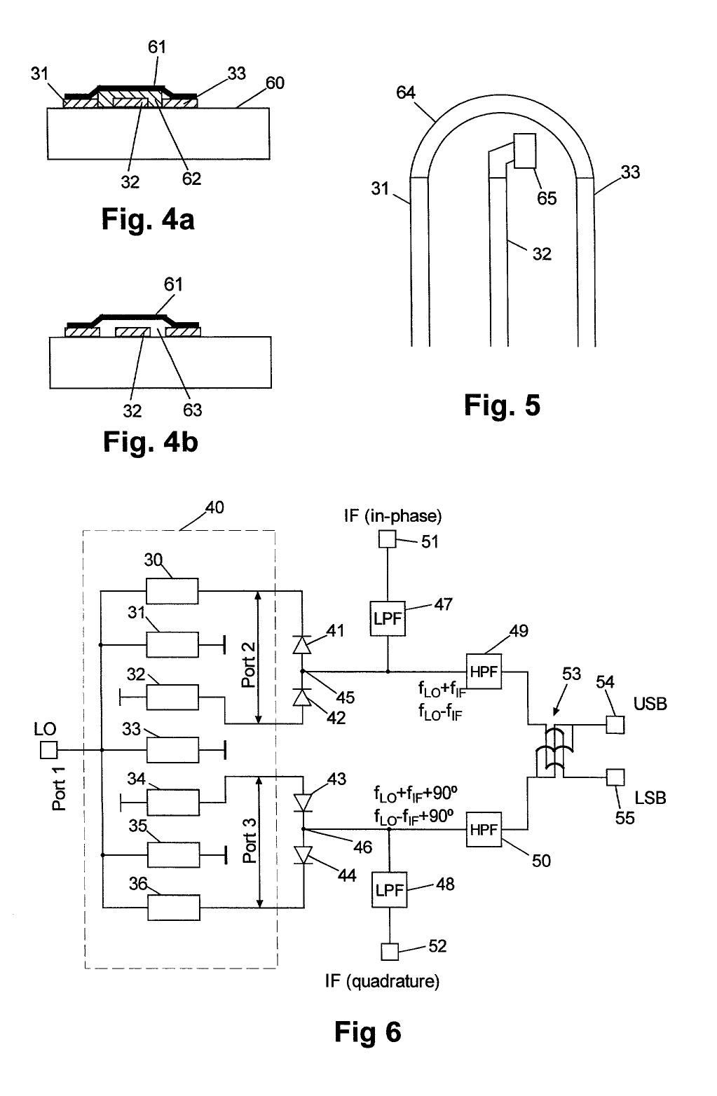

The formation of an airbridge is illustrated in FIGS. 4a and 4b. In FIG. 4a the lines 31, 32 and 33 shown in FIG. 3 are shown in cross-section on a substrate 60. To form the airbridge a photoresist 62 is deposited onto the substrate and a metallisation interconnect 61 is, in turn, deposited onto the photoresist 62 and the microstrips 31 and 33. Finally, the photoresist 62 is etched away to leave a airgap 63 (see FIG. 4b). An alternative to the use of an airbridge is the use of a bypass interconnect, as illustrated in FIG. 5. Here a bypass track 64 is deposited onto the substrate (not shown) carrying the strips 30-36 using the thin-film manufacturing technique.

The embodiment illustrated in FIG. 3 shows symmetry of line width (parameter w) and line spacing (parameter s) between the two halves of the balun centred on line 33. This measure provides equal power distribution between the balanced ports. If unequal distribution were to be required in a particular application, then these parameters may be made to differ between the two halves. In practice, the actual values of line width and line spacing will be determined by the need to match the balun to the driving and driven circuitry to which it is connected, in accordance with principles well known to those skilled in the art. In practice, these dimensions may well be determined using spectral-domain techniques described in the paper “Spectral Domain Emittance Approach for Dispersion Characteristics of Generalised Printed Transmission Lines” by T. Itoh, IEEE Transactions, MTT-287, July 1980, pp 733-738. As regards the coupling of the balun to external circuitry, it may be employed as a matching network interfacing with other circuitry, as well as a balun as such. In this case it will also act as an impedance transformer.

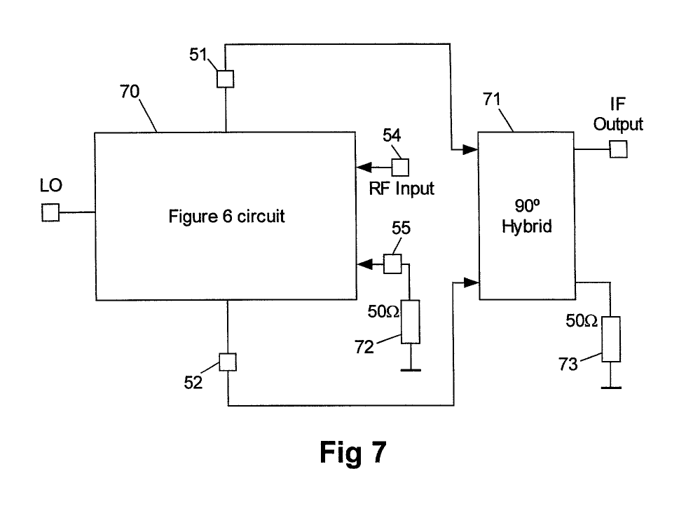

An application of the balun according to the present invention is depicted in FIG. 6. In FIG. 6 block 40 represents the dual balun described above having lines 30-36 configured to form Ports 1, 2 and 3 as shown in FIG. 3. The balanced ports, Ports 2 and 3, each feed an arrangement of two diodes connected in series. These are diodes 41 and 42 for Port 2 and diodes 43 and 44 for Port 3. The junctions 45, 46 of the two diode arrangements are taken to the inputs of respective low-pass filters 47, 48 and to the inputs of repective high-pass filters 49, 50. The outputs of the low-pass filters form the IF input ports 51, 52 of the mixer. Thus these filters isolate the ports 51, 52 from high frequencies within the mixer. Input 51 is an in-phase signal, while input 52 is in quadrature thereto. There therefore appear at the inputs of the high-pass filters 49, 50 a pair of sidebands of frequency f_{LO}+f_{if}, f_{LO}−f_{IF} and f_{LO}+f_{IF}+90°, f_{LO}+f_{IF}+90°, respectively. The outputs of the high-pass filters (which may conveniently be constituted by simple capacitors) are fed into a 90-degree hybrid coupler, which in the illustrated example is a Lange coupler 53. The Lange coupler is used to separate the upper sideband 54 from the lower sideband 55. The sideband outputs are unbalanced, like the local-oscillator input port, Port 1.

The low-pass filter should preferably have at least 20 dB attenuation for the local-oscillator and RF signals and less than 0.3 dB attenuation for the IF signals. Conversely, the high-pass filter should preferably have 20 dB attenuation for the IF signals and less than 0.3 dB attenuation for the local-oscillator and RE signals.

Sufficient isolation between the local-oscillator and RF-input sections of the mixer is ensured by arranging for the diode-pairs to be excited in their odd mode. (This makes Port 1 appear as ground as far as the RF inputs are concerned and makes the diode junctions 45, 46 appear as ground as far as the local oscillator input is concerned). As well as feeding the RF input signals (which may be at IF frequency in practice) into the mixer, the low-pass filters 47 and 48 may also pass the DC voltage levels necessary to bias the diodes. The filters 47, 48 may take the form of spiral inductors or multiple-pole filters, depending on the bandwidth of the IF signals.

In addition to the illustrated mixer arrangement, the same circuit can be employed as a down converter. A suitable circuit arrangement is shown in FIG. 7, in which the mixer circuit shown in FIG. 6 is represented by a functional block 70. This time, however, what were the IF inputs of the mixer are now outputs feeding an additional 90° IF-hybrid 71. Likewise, the outputs 54, 55 of the 90° hybrid (e.g. Lange coupler) in the former mixer are now inputs taken to an RF input signal and a ground-referenced referenced load 72, respectively. Finally, one of the outputs of the 90° hybrid 71 forms an IF output for the downconverter arrangement, while the other output is terminated in a matching load 73. (The image frequency of the RF input appears at this output and is absorbed in the load). The local oscillator input (LO) of the former mixer (block 70) continues to be the local oscillator input for the downconverter.

The balun, mixer and downconverter described can be implemented in MIC (microwave integrated circuit) or MMIC (monolithic microwave integrated circuit) technology.

1. A balun, comprising seven adjacently disposed coupled lines (30-36), an unbalanced port (Port 1) and first and second balanced ports (Ports 2 and 3), wherein second, third and fourth of the seven lines (32, 31, 30) lie adjacent each other in sequence on one side of a first of the seven lines (33), with the second line adjacent the first, and fifth, sixth and seventh of the seven lines (34, 35, 36) lie adjacent each other in sequence on the other side of the first line (33), with the fifth line (34) adjacent the first, the lines having corresponding first ends and corresponding second ends, the first end of the first line (33) serving as the unbalanced port (Port 1) and the second end of the first line (33) being connected to a ground reference, the first ends of the first, third, fourth, sixth and seventh lines (33, 31, 30, 35, 36) being connected to each other by conductive interconnect means (37), the second ends of the third and sixth lines (31, 35) being connected to a ground reference, the first ends of the second and fifth lines (32, 34) being connected to a ground reference, the second ends of the second and fourth lines (32, 30) serving as the first balanced port and the second ends of the fifth and seventh lines (34,36) serving as the second balanced port.

2. Balun according to claim 1, wherein the coupled length of each of the lines is approximately equal to one-quarter of the average operating wavelength of the balun.

3. Balun according to claim 1, wherein one or more of the interconnect means is an airbridge.

4. Balun according to claim 1, wherein one or more of the interconnect means is a bypass.

5. Single-sideband mixer arrangement comprising a balun according to claim 1.

6. Mixer arrangement according to claim 5, wherein the unbalanced port (Port 1) is connected to a local-oscillator source (LO); the first and second balanced ports (Ports 1 and 2) are connected to respective first and second diode-mixer arrangements (41, 42; 43, 44); an output (45) of the first diode-mixer arrangement is connected to a first RF input port (51) and to a first input of a 90° hybrid and an output (46) of the second diode-mixer arrangement is connected to a second RF input port (52) and to a second input of the 90° hybrid, first and second outputs of the 90° hybrid constituting the upper-sideband and lower-sideband outputs, respectively, of the mixer arrangement.

7. Mixer arrangement according to claim 6, wherein each of the diode-mixer arrangements comprises a pair of diodes connected in series across the relevant balanced port, the diode-mixer output being constituted by the junction between the two diodes.

8. Mixer arrangement as claimed in claim 6, wherein the connections between the diode-mixer arrangements and the RF ports are by way of respective low-pass filters (47, 48).

9. Mixer arrangement according to claim 6, wherein the connections between the diode-mixer arrangements and the 90°-hybrid inputs are by way of respective high-pass filters (49, 50).

10. Mixer arrangement according to claim 6, wherein the 90° hybrid is a Lange coupler (53).

11. Downconverter arrangement, comprising a balun according to claim 1.

12. Downconverter arrangement according to claim 11, wherein the unbalanced port is connected to a local-oscillator source (LO); the first and second balanced ports are connected to respective first and second diode-mixer arrangements (41, 42; 43, 44); an output (45) of the first diode-mixer arrangement is connected to a first IF output port (51) and to a first output of a first 90° hybrid (53) and an output (46) of the second diode-mixer arrangement is connected to a second IF output port (52) and to a second output of the first 90° hybrid (53); a first input (54) of the first 90° hybrid constitutes the RF input port of the downconverter and a second input of the first 90° hybrid is terminated by a load (72), the first and second IF output ports (51, 52) being connected to first and second inputs, respectively, of a second 90° hybrid (71), a first output of the second 90° hybrid constituting the IF output port of the downconverter and a second output of the second 90° hybrid being terminated by a load (73).

13. Downconverter arrangement according to claim 12, wherein each of the diode-mixer arrangements comprises a pair of diodes (41, 42; 43, 44) connected in series across the relevant balanced port, the diode-mixer output being constituted by the junction (45, 46) between the two diodes.

14. Downconverter arrangement according to claim 12, wherein the connections between the diode-mixer arrangements and the IF ports are by way of respective low-pass filters (47, 48).

15. Downconverter arrangement according to claim 12, wherein the connections between the diode-mixer arrangements and the outputs of the first 90° hybrid (53) are by way of respective high-pass filters (49, 50).

16. Downconverter arrangement according to claim 12, wherein the first and/or second 90° hybrid (53, 71) is a Lange coupler.
